(19) United States
(12) Patent Application Publication
(10) Pub. No.: US 2004/0087202 A1
(43) Pub. Date: May 6, 2004

(54) Slotted guide pin and latch assembly

(75) Inventors: James S.C. Baccei, Terryville, CT (US); James M. Giroux, Thomaston, CT (US)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Litton Systems, Inc.

(21) Appl. No.: 10/286,758

(22) Filed: Nov. 4, 2002

(51) Int. Cl. H01R 13/64

(52) U.S. Cl. 439/378

(57) ABSTRACT

A slotted guide pin and latch assembly has one or more slotted guide pins that are located on an electrical connector, for example. One or more guide sockets respectively corresponding to the one or more slotted guide pins are located on a mating connector or mating surface. The slotted guide pins and their corresponding guide sockets guide and latch the electrical connector to the mating connector or mating surface.

### CROSS-REFERENCE TO RELATED APPLICATIONS AND CLAIM OF PRIORITY

The present application is a continuation-in-part of co-pending U.S. patent application Ser. No. 10/294,859, filed in the U.S. Patent and Trademark Office on Sep. 5, 2002, which,in turn, is a Continuation-In-Part of U.S. patent application Ser. No. 10/036,796, filed in the U.S. Patent and Trademark Office on Jan. 7, 2002 and priority is hereby claimed under 35 USC 120 of these applications and of Provisional Patent Application Serial No. 60/260,893 filed in the U.S. Patent and Trademark Office on Jan. 12, 2001, and Provisional Patent Application Serial No. 60/328,396 filed in the U.S. Patent and Trademark Office on Oct. 12, 2001, upon which the grandparent application is based. The disclosures of these applications are hereby incorporated by reference in their entirety into the present specification.

### BACKGROUND OF THE INVENTION

1. Field of the Invention

The present invention relates to a slotted guide pin and latch assembly. More particularly, the present invention relates to a slotted guide pin and latch assembly in which one or more slotted guide pins are located on an electrical connector, for example. One or more guide sockets respectively corresponding to the one or more slotted guide pins are located on a mating connector or mating surface. The slotted guide pins and their corresponding guide sockets guide and latch the electrical connector to the mating connector or mating surface.

2. Description of the Related Art

Electrical connectors are used to electrically connect electrical components or devices into electrical assemblies. To provide a secure engagement between an electrical connector and its mating surface (which can be either a mating electrical connector or a printed circuit board, for example), one or more guide pins or guide posts are located on the electrical connector and corresponding mating guide sockets are located on the mating electrical connector or printed circuit board.

The guide pin or pins and mating guide socket or sockets serve to guide the engagement between the electrical connector and its mating electrical connector or printed circuit board. If the guide pin or pins and mating guide socket or sockets are designed to latch together, then they also serve to latch the electrical connector with its mating electrical connector or printed circuit board. In addition, the guide pin or pins and mating guide socket or sockets, if electrically conductive, can be used to provide a grounding measure to discharge electrostatic charges prior to the actual engagement of the electrical connector with its mating electrical connector or printed circuit board, thus protecting electrical components from being damaged by electrostatic charges.

U.S. Pat. No. 6,074,236 to Wu, for example, discloses a guide post structure of an electrical connector. The disclosed guide post includes an elongated conductive body having a threaded male section which engages with a corresponding threaded female section in the connector and also having a front section extending from the male threaded section. The front section has a slot for receiving a conductive spring member having two spaced arms. When the guide post is inserted into corresponding receptacle holes defined in a mating connector, the resiliency of the arms are maintained in contact with the inner surface of the corresponding receptacle hole, thereby providing an electrical and mechanical engagement therebetween.

Similarly, U.S. Pat. No. 4,861,132 to Moulin, U.S. Pat. No. 5,125,849 to Briggs et al., U.S. Pat. No. 6,007,364 to Wu, and U.S. Pat. No. 6,074,235 to Brandberg et al. each also disclose guide pin or post arrangements. While each of these arrangements and the arrangement of the aforecited Wu patent serve to guide and in some cases latch an electrical connector and its mating connector or mating surface, these arrangements include many precision components which result in high manufacturing and assembly costs.

### SUMMARY OF THE INVENTION

In view of the above, it is an object of the present invention to provide a simplified slotted guide pin and latch assembly for smoothly and positively guiding and latching an electrical connector, for example, to a mating electrical connector or printed circuit board.

These and other objects of the present invention can be achieved by providing a slotted guide pin adapted to guide and latch a first assembly to a second assembly having a mating guide socket, said slotted guide pin comprising: a first portion adapted to attach said slotted guide pin to the first assembly; a second portion, located adjacent to and attached to said first portion, said second portion being cylindrical in shape and having at least two slots, each slot being in a plane passing through an axis of said second portion and extending longitudinally along said second portion; and a third portion, located adjacent to and attached to said second portion and having an axis coextensive with said axis of said second portion, said third portion having said at least two slots of said second portion extending therethrough.

These and other objects of the present invention can also be achieved by providing a slotted guide pin and mating guide socket adapted to guide and latch a first assembly to a second assembly, said slotted guide pin comprising: a first portion adapted to attach said slotted guide pin to the first assembly; a second portion, located adjacent to and attached to said first portion, said second portion being cylindrical in shape and having at least two slots, each slot being in a plane passing through an axis of said second portion and extending longitudinally along said second portion; and a third portion, located adjacent to and attached to said second portion and having an axis coextensive with said axis of said second portion, said third portion having said at least two slots of said second portion extending therethrough; and said mating guide socket adapted to attach to said second assembly and comprising: a first aperture extending partially through said mating guide socket, said first aperture having a diameter smaller than that of said third portion; and a second aperture extending partially through said mating guide socket and adjacent said first aperture, said second aperture having an axis coextensive with an axis of said first aperture and having a diameter equal to or greater than that of said third portion.

Furthermore, these and other objects of the present invention can also be achieved by providing a electrical connector having a slotted guide pin adapted to guide and latch it to an assembly having a mating guide socket, said slotted guide pin comprising: a first portion adapted to attach said slotted guide pin to the electrical connector; a second portion, located adjacent to and attached to said first portion, said second portion being cylindrical in shape and having at least two slots, each slot being in a plane passing through an axis of said second portion and extending longitudinally along said second portion; and a third portion, located adjacent to and attached to said second portion and having an axis coextensive with said axis of said second portion, said third portion having said at least two slots of said second portion extending therethrough.

Lastly, these and other objects of the present invention can also be achieved by providing an electrical connector having a slotted guide pin and mating guide socket adapted to guide and latch it to an assembly, said slotted guide pin comprising: a first portion adapted to attach said slotted guide pin to the assembly; a second portion, located adjacent to and attached to said first portion, said second portion being cylindrical in shape and having at least two slots, each slot being in a plane passing through an axis of said second portion and extending longitudinally along said second portion; and a third portion, located adjacent to and attached to said second portion and having an axis coextensive with said axis of said second portion, said third portion having said at least two slots of said second portion extending therethrough; and said mating guide socket adapted to attach to the assembly and comprising: a first aperture extending partially through said mating guide socket, said first aperture having a diameter smaller than that of said third portion; and a second aperture extending partially through said mating guide socket and adjacent said first aperture, said second aperture having an axis coextensive with an axis of said first aperture and having a diameter equal to or greater than that of said third portion.

### BRIEF DESCRIPTION OF THE DRAWINGS

The foregoing and a better understanding of the present invention will become apparent from the following detailed description of an example embodiment and the claims when read in connection with the accompanying drawings, all forming a part of the disclosure of this invention. While the foregoing and following written and illustrated disclosure focuses on disclosing an example embodiment of the invention, it should be clearly understood that the same is by way of illustration and example only and that the invention is not limited thereto. The spirit and scope of the present invention are limited only by the terms of the appended claims.

The following represents brief descriptions of the drawings, wherein:

FIG. 1 is a view of a slotted guide pin in accordance with an example embodiment of the present invention.

FIG. 2 is a view of a guide socket in accordance with an example embodiment of the present invention.

FIG. 3 is a partial cutaway side view of the slotted guide pin of FIG. 1 being mated with the guide socket of FIG. 2.

FIG. 4 is a partial cutaway side view of the slotted guide pin of FIG. 1 after being fully mated with the guide socket of FIG. 2.

FIGS. 5 and 6 are respectively front and side views of the slotted guide pin of FIG. 1.

FIG. 7 is a view of an application of the use of slotted guide pins and guide sockets in accordance with an embodiment of the present invention in conjunction with a connector arrangement disclosed in the parent application upon which the present application is based.

### DETAILED DESCRIPTION

In the following detailed description of the subject invention, like reference numerals and characters may be used to designate identical, corresponding, or similar components in differing drawing figures. Furthermore, example sizes/models/values/ranges may be given, although the present invention is not limited thereto. Where specific details are set forth in order to describe an example embodiment of the invention, it should be apparent to one skilled in the art that the invention can be practice without or with variations of these specific details.

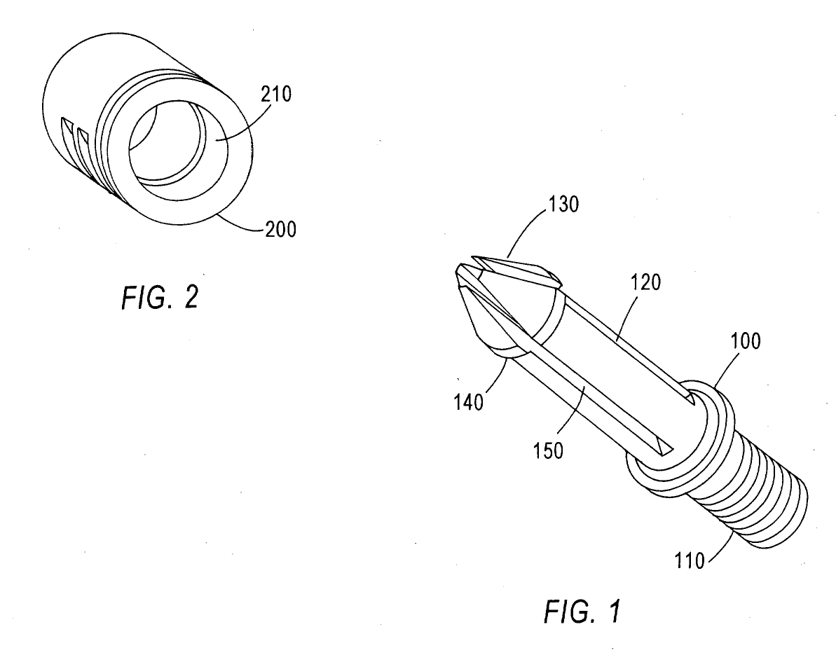

FIG. 1 and FIG. 2 are views of a slotted guide pin 100 and a mating guide socket 200 in accordance with an example embodiment of the present invention. Normally, one or more slotted guide pins 100 are attached to an electrical connector (not shown), for example, by means of the threaded portion 110 being mated with a corresponding threaded aperture in the electrical connector. It is of course understood by one skilled than the art that the slotted guide pin 100 can be attached to the electrical connector, for example, by means other than threaded mating portions. For example, welding, brazing, or soldering can be used as well as attaching with an adhesive.

Similarly, one or more of the mating guide sockets 200 are attached to a corresponding mating connector or mating surface such as a printed circuit board (not shown), for example, by any standard attaching means including those noted above with regard to the slotted guide pin 100.

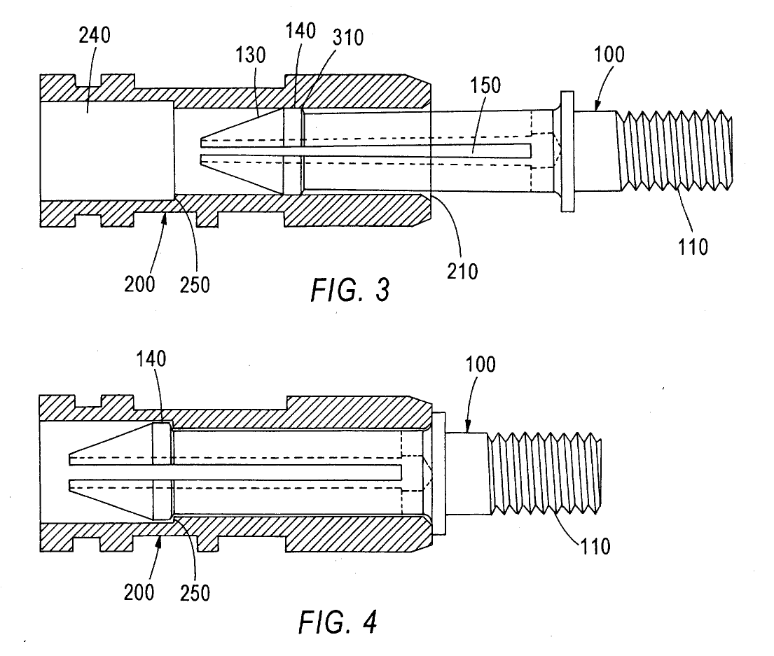

To mate the electrical connector with its corresponding mating connector or mating surface, the elongated slotted portion 120 of the one or more slotted guide pins 100 are mated with the corresponding apertures 210 of the one or more corresponding mating guide sockets 200 as best shown in FIGS. 3 and 4.

Referring to FIGS. 3 and 4, initially, the conical end 130 of the slotted guide pin 100 is inserted into the entrance of the aperture 210 of the guide socket 200. The diameter of the shoulder portion 140 of the slotted guide pin 100 is fabricated so as to have a diameter which is larger than that of the aperture 210 of the guide socket 200.

The guide pin 100 is fabricated of a resilient material, such as beryllium copper, which, by virtue of the slots 150, allow the slotted portion 120 of the slotted guide pin 100 to be compressed so as to allow the slotted portion 120 of the slotted guide pin 100 enter the aperture 210 of the guide socket 200. It is to be noted that the shape and dimensions of the slotted portion 120 of the slotted guide pin 100, the number of slots 150, the diameter of the shoulder 140, the shape and angle of the conical end 130, the shape and diameter of the aperture 210 of the guide socket 200, and the choice of material used to fabricate the guide pin 100, among other parameters, determine the insertion force necessary to mate the slotted guide pin 100 with its corresponding guide socket 200.

Referring again to FIGS. 3 and 4, the guide socket 200 includes a second aperture portion 240 having a larger diameter than the aperture portion 210. If the diameter of the second aperture portion 240 is made equal to or greater than the diameter of the shoulder 140 of the slotted guide pin 100, then the slotted portion 120 of the slotted guide pin 100 is uncompressed upon the edge 310 of the conical portion 130 reaching the second aperture portion 240.

Furthermore, the edge 310 abutting the ledge 250 located at the juncture of the aperture 210 and second aperture portion 240 serves to latch the slotted guide pin 100 with the guide socket 200 by virtue of the being necessary to compress the slotted portion 120 of the slotted guide pin 100 to unmate the slotted guide pin 100 from the guide socket 200. As with the insertion force necessary to mate the slotted guide pin 100 with its corresponding guide socket 200, the shape and dimensions of the slotted portion 120 of the slotted guide pin 100, the number of slots 150, the shape and diameter of the shoulder 140, the diameter of the aperture 210, the diameter of the aperture 240, and the shape of the edge 310 and the ledge 250 determine the force needed to unlatch the slotted guide pin 100 from the guide socket 200.

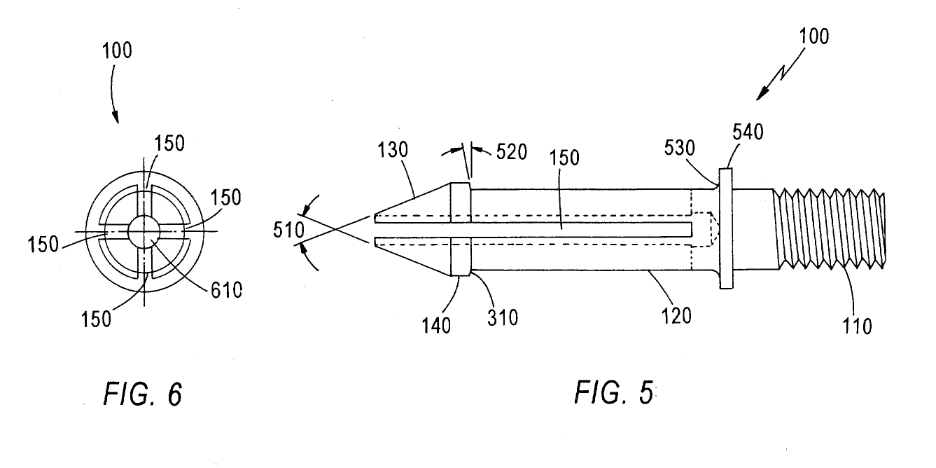

Referring to FIGS. 5 and 6, which are respectively front and side views of the slotted guide pin 100, an aperture 610, essentially hidden in the other drawing figures, is located in the center of the slotted portion 120 of the slotted guide pin 100. The aperture 610 allows for a greater compression of the slotted portion 120 of the slotted guide pin 100 than would be available if only the slots 150 were present. Furthermore, the diameter of the aperture 610 also serves as another parameter to control the insertion force needed to insert and latch the slotted guide pin 100 into the guide socket 200 and the force needed to unlatch the slotted guide pin 100 from the guide socket 200.

Furthermore, as noted previously, the angle 510 of the conical end 130 is one parameter which determines the insertion force needed to insert the slotted guide pin 100 into the guide socket 200. Similarly, the angle 520 of the edge 310 is one parameter which determines the unlatching force needed to unlatch the slotted guide pin 100 from the guide socket 200. For example, the angle 510 can be 40 degrees while the angle 520 can be 12 degrees. Still furthermore, the transition 530 between the slotted portion 120 and a rear shoulder 540 of the slotted portion can be rounded or chamfered so as to match a rounded portion or chamfered of the aperture 210 of the guide socket 200.

Lastly, while the slotted portion 120 of the slotted guide pin 100 has been illustrated as being cylindrical with a constant diameter, it has been found that providing a reverse taper on the slotted portion 120, that is, decreasing the diameter along the slotted portion such that the diameter adjacent the rear shoulder 540 is smaller than that adjacent the edge 310, often allows improved wear and retention characteristics.

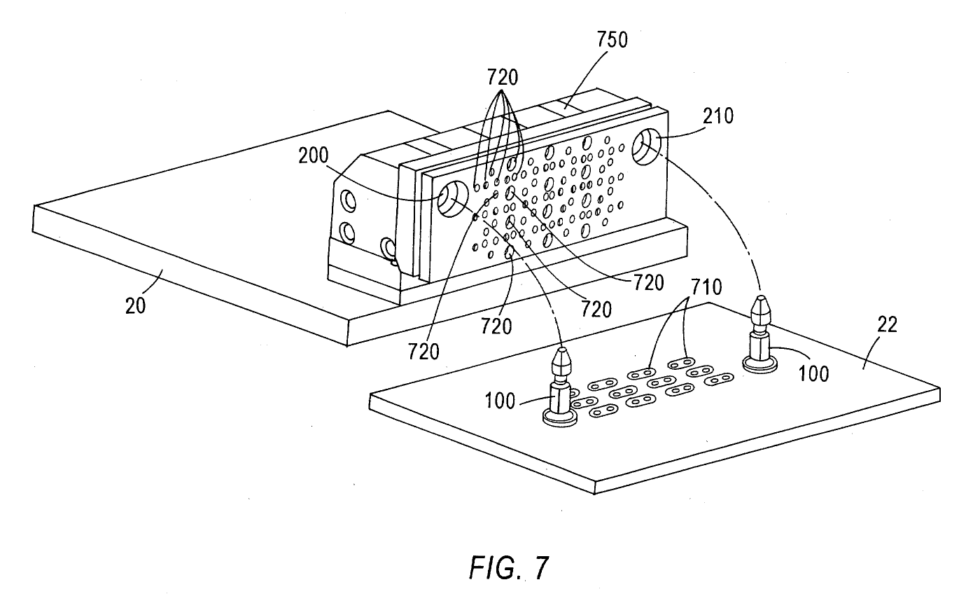

FIG. 7 is a view of an application of the use of slotted guide pins and guide sockets in accordance with an embodiment of the present invention in conjunction with a connector arrangement disclosed in the parent application upon which the present application is based. The connector 750 is attached to a printed circuit board 20. The connector 750 is guided and latched to a circuit board 22 by means of a pair of slotted guide pins 100 affixed to the circuit board 22 and guide sockets 200 located within the connector 750. Upon the connector 750 being latched to the circuit board 22, electrical connections are made between contact points 720 of the connector 750 and mating contact points 710 of the circuit board 22.

This concludes the detailed description. Although the present invention has been described with reference to an illustrative embodiment thereof, it should be understood that numerous other modifications and embodiments can be devised by those skilled in the art that will fall within the spirit and scope of the principles of this invention. More particularly, reasonable variations and modifications are possible in the component parts and/or arrangements of the present invention within the scope of the foregoing disclosure, drawings, and appended claims without departing from the spirit of the invention. In addition to variations and modifications in the component parts and/or arrangements, alternative uses will also be apparent to those skilled in the art.

For example, while the slotted portion 120 of the slotted guide pin 100 is shown as including four slots 150, the present invention is not limited thereto. A greater number or lesser number of slots 150 can be provided, depending upon the application. In addition, the aperture 610 can be eliminated in certain applications, depending upon the available adjustment of the other parameters, such as the number of slots 150 and their thickness.

Furthermore, while a conical portion 130 of the slotted guide pin 100 has been shown, the present invention is not limited thereto. A hemispherical shape or a blunter shape can be utilized, depending upon the application.

Still furthermore, while the aperture 210 of the guide socket 200 has been illustrated as being of a constant diameter, the present invention is not limited thereto. In certain applications, the aperture 210 can be of varying diameter, such as having a taper, to control the insertion force needed to mate the slotted guide pin 100 with the guide socket 200.

Lastly, as noted previously, while the present invention has been indicated as being useful for guiding unlatching an electrical connector with a corresponding mating connector or mating surface such as a printed circuit board, it is to be understood that the use of the present invention is not limited thereto.

What is claimed is:

1. A slotted guide pin adapted to guide and latch a first assembly to a second assembly having a mating guide socket, said slotted guide pin comprising:
a first portion adapted to attach said slotted guide pin to the first assembly;
a second portion, located adjacent to and attached to said first portion, said second portion being cylindrical in shape and having at least two slots, each slot being in a plane passing through an axis of said second portion and extending longitudinally along said second portion; and
a third portion, located adjacent to and attached to said second portion and having an axis coextensive with said axis of said second portion, said third portion having said at least two slots of said second portion extending therethrough.

2. The slotted guide pin of claim 1, wherein said first portion comprises a threaded assembly adapted to attach to a corresponding threaded assembly of the first assembly.

3. The slotted guide pin of claim 1, wherein said at least two slots of said second portion comprises four slots.

4. The slotted guide pin of claim 1, wherein said third portion comprises a conical shape.

5. The slotted guide pin of claim 1, wherein said second portion comprises an aperture located coaxially with said axis of said second portion and extending longitudinally through said second portion.

6. The slotted guide pin of claim 1, wherein said third portion comprises an aperture located coaxially with said axis of said third portion and extending longitudinally through said third portion.

7. The slotted guide pin of claim 1, wherein said second and third portions comprise an aperture located coaxially with said axis of said second and third portions and extending longitudinally through said second and third portions.

8. The slotted guide pin of claim 1, further comprising a first shoulder located between said first and second portions, said first shoulder having a diameter greater than that of said first and second portions.

9. The slotted guide pin of claim 1, further comprising a second shoulder located between said second and third portions, said second shoulder having a diameter greater than that of said second and third portions.

10. The slotted guide pin of claim 1, wherein said second portion has a diameter that is constant along its length.

11. The slotted guide pin of claim 1, wherein said second portion has a diameter that varies along its length.

12. The slotted guide pin of claim 10, wherein the diameter of said second portion adjacent said third portion is greater than the diameter of said second portion adjacent said first portion.

13. A slotted guide pin and mating guide socket adapted to guide and latch a first assembly to a second assembly, said slotted guide pin comprising:
a first portion adapted to attach said slotted guide pin to the first assembly;
a second portion, located adjacent to and attached to said first portion, said second portion being cylindrical in shape and having at least two slots, each slot being in a plane passing through an axis of said second portion and extending longitudinally along said second portion; and
a third portion, located adjacent to and attached to said second portion and having an axis coextensive with said axis of said second portion, said third portion having said at least two slots of said second portion extending therethrough; and
said mating guide socket adapted to attach to said second assembly and comprising:
a first aperture extending partially through said mating guide socket, said first aperture having a diameter smaller than that of said third portion; and
a second aperture extending partially through said mating guide socket and adjacent said first aperture, said second aperture having an axis coextensive with an axis of said first aperture and having a diameter equal to or greater than that of said third portion.

14. The slotted guide pin and mating guide socket of claim 12, wherein said mating guide socket further comprises a ledge located between said first and second apertures.

15. The slotted guide pin and mating guide socket of claim 12, wherein said first aperture of said mating guide socket is chamfered at an end thereof away from said first aperture.

16. The slotted guide pin and mating guide socket of claim 12, wherein said first portion comprises a threaded assembly adapted to attach to a corresponding threaded assembly of the first assembly.

17. The slotted guide pin and mating guide socket of claim 12, wherein said at least two slots of said second portion comprises four slots.

18. The slotted guide pin and mating guide socket of claim 12, wherein said third portion comprises a conical shape.

19. The slotted guide pin and mating guide socket of claim 12, wherein said second portion comprises an aperture located coaxially with said axis of said second portion and extending longitudinally through said second portion.

20. The slotted guide pin and mating guide socket of claim 12, wherein said third portion comprises an aperture located coaxially with said axis of said third portion and
extending longitudinally through said third portion.

21. The slotted guide pin and mating guide socket of claim 12, wherein said second and third portions comprise an aperture located coaxially with said axis of said second and third portions and extending longitudinally through said second and third portions.

22. The slotted guide pin and mating guide socket of claim 12, further comprising a first shoulder located between said first and second portions, said first shoulder having a diameter greater than that of said first and second portions.

23. The slotted guide pin and mating guide socket of claim 12, wherein said second portion has a diameter that is constant along its length.

24. The slotted guide pin and mating guide socket of claim 12, wherein said second portion has a diameter that varies along its length.

25. The slotted guide pin and mating guide socket of claim 23, wherein the diameter of said second portion adjacent said third portion is greater than the diameter of said second portion adjacent said first portion.

26. An electrical connector having a slotted guide pin adapted to guide and latch it to an assembly having a mating guide socket, said slotted guide pin comprising:
a first portion adapted to attach said slotted guide pin to the electrical connector;
a second portion, located adjacent to and attached to said first portion, said second portion being cylindrical in shape and having at least two slots, each slot being in a plane passing through an axis of said second portion and extending longitudinally along said second portion; and
a third portion, located adjacent to and attached to said second portion and having an axis coextensive with said axis of said second portion, said third portion having said at least two slots of said second portion extending therethrough.

27. The electrical connector of claim 25, wherein the assembly having a mating guide socket comprises another electrical connector arranged to mate with the electrical connector.

28. The electrical connector of claim 25, wherein the assembly having a mating guide socket comprises a printed circuit board arranged to mate with the electrical connector.

29. The electrical connector of claim 25, wherein said first portion comprises a threaded assembly adapted to attach to a corresponding threaded assembly of the first assembly.

30. The electrical connector of claim 25, wherein said at least two slots of said second portion comprises four slots.

31. The electrical connector of claim 25, wherein said third portion comprises a conical shape.

32. The electrical connector of claim 25, wherein said second portion comprises an aperture located coaxially with said axis of said second portion and extending longitudinally through said second portion.

33. The electrical connector of claim 25, wherein said third portion comprises an aperture located coaxially with said axis of said third portion and extending longitudinally through said third portion.

34. The electrical connector of claim 25, wherein said second and third portions comprise an aperture located coaxially with said axis of said second and third portions and extending longitudinally through said second and third portions.

35. The electrical connector of claim 25, further comprising a first shoulder located between said first and second portions, said first shoulder having a diameter greater than that of said first and second portions.

36. The electrical connector of claim 25, further comprising a second shoulder located between said second and third portions, said second shoulder having a diameter greater than that of said second and third portions.

37. An electrical connector having a slotted guide pin and mating guide socket adapted to guide and latch it to an assembly, said slotted guide pin comprising:
a first portion adapted to attach said slotted guide pin to the assembly;
a second portion, located adjacent to and attached to said first portion, said second portion being cylindrical in shape and having at least two slots, each slot being in a plane passing through an axis of said second portion and extending longitudinally along said second portion; and
a third portion, located adjacent to and attached to said second portion and having an axis coextensive with said axis of said second portion, said third portion having said at least two slots of said second portion extending therethrough; and
said mating guide socket adapted to attach to the assembly and comprising:
a first aperture extending partially through said mating guide socket, said first aperture having a diameter smaller than that of said third portion; and
a second aperture extending partially through said mating guide socket and adjacent said first aperture, said second aperture having an axis coextensive with an axis of said first aperture and having a diameter equal to or greater than that of said third portion.

38. The electrical connector of claim 36, wherein said mating guide socket further comprises a ledge located between said first and second apertures.

39. The electrical connector of claim 36, wherein said first aperture of said mating guide socket is chamfered at an end thereof away from said first aperture.

40. The electrical connector of claim 36, wherein said first portion comprises a threaded assembly adapted to attach to a corresponding threaded assembly of the first assembly.

41. The electrical connector of claim 36, wherein said at least two slots of said second portion comprises four slots.

42. The electrical connector of claim 36, wherein said third portion comprises a conical shape.

43. The electrical connector of claim 36, wherein said second portion comprises an aperture located coaxially with said axis of said second portion and extending longitudinally through said second portion.

44. The electrical connector of claim 36, wherein said third portion comprises an aperture located coaxially with said axis of said third portion and extending longitudinally through said third portion.

45. The electrical connector of claim 36, wherein said second and third portions comprise an aperture located coaxially with said axis of said second and third portions and extending longitudinally through said second and third portions.
